(19) United States
(12) Patent Application Publication
(10) Pub. No.: US 2025/0335476 A1
(43) Pub. Date: Oct. 30, 2025

(54) Virtual Agent

(71) Applicant: Healthcare Interactive, Inc., Glenwood, MD (US)

(72) Inventors: Henry H. Cha, Glenelg, MD (US); Xavier Cha, Glenwood, MD (US); Alex Straub, Glenwood, MD (US)

(21) Appl. No.: 18/652,797

(22) Filed: May 1, 2024

Related U.S. Application Data
(63) Continuation-in-part of application No. 18/650,875, filed on Apr. 30, 2024, now abandoned.

(51) Int. Cl. G06F 16/332; H04L 51/02

(52) U.S. Cl. CPC G06F 16/3329; G06F 16/3326; H04L 51/02

(57) ABSTRACT

A virtual agent system including a device processor and a non-transitory computer readable medium having stored thereon instructions, executable by the processor, for performing the following steps: receiving user input including a first request for information; directing a query to at least one knowledge expert resource based on the first request for information; receiving a set of data from the at least one knowledge expert resource; and delivering, to the user, a response to the first request for information based on the set of data; wherein delivering the response to the user is performed with a customizable persona.

### CROSS-SECTION TO RELATED APPLICATIONS

This application is a continuation-in-part of U.S. application Ser. No. 18/650,875, filed Apr. 30, 2024, and entitled “Virtual Agent,” the entire disclosure of which is incorporated herein by reference.

### TECHNICAL FIELD

The present disclosure generally relates to virtual agents and, more particularly, to virtual agents with customizable personas and stackable resources.

### BACKGROUND

Virtual agents are computer-generated agents that can interact with users. Virtual agents may communicate with human users in a natural language and work with or otherwise assist users with the performance of various tasks, such as information retrieval and obtaining rule-based recommendations. Informally, virtual agents may be referred to as “chatbots.” Virtual agents may be used by corporations to assist customers with tasks such as retrieving membership or benefits information. Using virtual agents may offer a corporation advantages by reducing operational costs of running call centers. However, traditionally, virtual agents may present a cold, matter of fact persona that can be frustrating or even offensive to some users. In addition, virtual agents typically retrieve information from a single resource with all pertinent information, which may lead to the retrieval of too much information, without identifying the most relevant answer to the user's query. Frustrating or offensive interactions with virtual agents and/or lack of specificity with respect to information retrieval can lead to reduced customer satisfaction.

There is a need in the art for a system and method that addresses the shortcomings discussed above.

### SUMMARY

The present disclosure is directed to virtual agents with customizable personas and stackable resources.

In one aspect, the present disclosure is directed to a virtual agent system. The system may include a device processor and a non-transitory computer readable medium having stored thereon instructions, executable by the processor, for performing the following steps: receiving user input including a first request for information; directing a query to at least one knowledge expert resource based on the first request for information; receiving a set of data from the at least one knowledge expert resource; and delivering, to the user, a response to the first request for information based on the set of data; wherein delivering the response to the user is performed with a customizable persona.

In another aspect, the present disclosure is directed to a virtual agent system. The system may include a device processor and a non-transitory computer readable medium having stored thereon instructions, executable by the processor, for performing the following steps: receiving user input including a first request for information; directing a first query to a first knowledge expert resource based on the first request for information; receiving a first set of data from the first knowledge expert resource; directing a second query to a second knowledge expert resource based, at least in part, on the first set of data received from the first knowledge expert resource; receiving a second set of data from the second knowledge expert resource; and delivering, to the user, a response to the first request for information based on the second set of data.

In another aspect, the present disclosure is directed to a virtual agent system. The system may include a device processor and a non-transitory computer readable medium having stored thereon instructions, executable by the processor, for performing the following steps: receiving user input including a first request for information; based on predetermined prompt engineering, directing a query to at least one knowledge expert resource based on the first request for information; receiving a set of data from the at least one knowledge expert resource; and delivering, to the user, a response to the first request for information based on the set of data.

In another aspect, the present disclosure is directed to a virtual agent system. The system may include a device processor and a non-transitory computer readable medium having stored thereon instructions, executable by the processor, for performing the following steps: proactively directing a first query to a first knowledge expert resource based on the first request for information; receiving a first set of data from the first knowledge expert resource; directing a second query to a second knowledge expert resource based, at least in part, on the first set of data received from the first knowledge expert resource; receiving a second set of data from the second knowledge expert resource; and delivering, to the user, information based on the second set of data.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of architecture for a virtual agent that corresponds with a user;

FIG. 2 is a schematic diagram of additional details of the virtual agent architecture;

FIG. 3 is a schematic diagram of an initialization process of a virtual agent with customizable personas;

FIG. 4 is a schematic diagram of an embodiment of a reinforcement learning process;

FIG. 5 is a schematic diagram of an embodiment of a virtual agent comprising a Deep Q Network process for learning;

FIG. 6 is a schematic diagram of an embodiment of a Deep Q Network process for learning in the context of a virtual agent;

FIG. 7 is a schematic diagram of the role of a persona in the context of the operation of a virtual agent; and

FIG. 8 is a schematic diagram illustrating a process of proactively retrieving data from multiple knowledge expert resources and providing information to a user based on the retrieved data.

### DESCRIPTION OF EMBODIMENTS

The present disclosure is directed to virtual agents with customizable personas and stackable resources. The persona of the virtual agent may be customizable between various emotional approaches. In addition, the virtual agent may be configured to retrieve information from various stackable resources. These stackable resources are referred to herein as knowledge experts or knowledge expert resources. These resources may comprise databases or repositories of information which is organized and categorized to facilitate accurate retrieval of information without overloading the user with responses that include extraneous information that is not relevant to the user's inquiry.

The disclosed virtual agent system may be configured to access these resources in a tiered approach. For example, the virtual agent may refer to a first knowledge expert resource based on the initial inquiry by the user. Then, based on information retrieved from the first knowledge expert resource, the system may choose a second knowledge expert resource to consult. For instance, if a user requests insurance benefits information regarding a given insurance claim, the system will first access a knowledge expert resource that includes information about the claim in question. Then, depending on what medical procedure the claim is for, the system will access a select second knowledge expert to retrieve the user's insurance benefits/coverage for the medical procedure to which the insurance claim is directed.

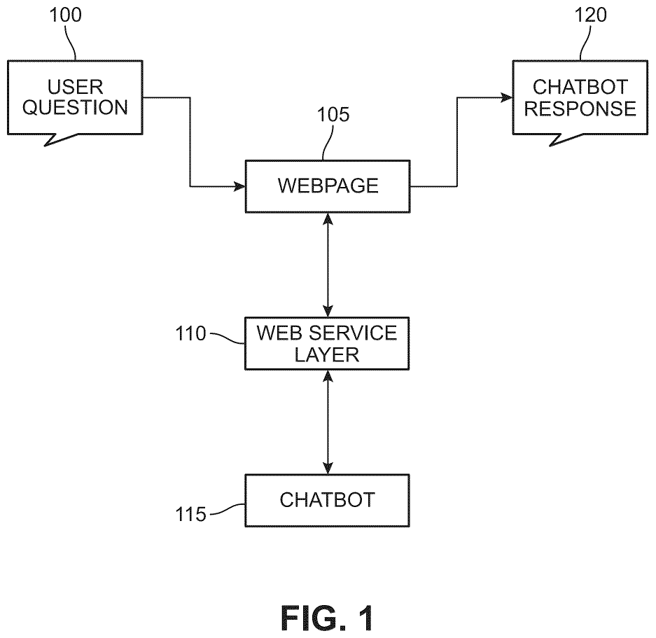

FIG. 1 is a schematic diagram of architecture for a virtual agent that corresponds with a user. As shown in FIG. 1, the user presents a question at step 100. In some embodiments the disclosed virtual agent may communicate with a customer via text-based communication (e.g., SMS or a chat-based application). That is, the virtual agent may be a so-called “chatbot.” In some embodiments, it is also possible that the disclosed virtual agent may communicate with the user via a video platform.

A virtual agent may include additional subsystems and modules to achieve the goal of conversing with a user. For example, an end user communicates with virtual agent through various modes, including text-based chat programs that may run on a desktop, laptop or mobile device, telephone calls, audio, and/or video calls transmitted over the internet, as well as other known modes of communication.

A virtual agent and associated systems for communicating with a virtual agent may include one or more user devices, such as a computer, a server, a database, and a network. For example, a virtual agent running on a server could communicate with a user over a network. In some embodiments, the network may be a wide area network (“WAN”), e.g., the Internet. In other embodiments, the network may be a local area network (“LAN”). For example, in a more remote location far from a metropolitan area, the Internet may not be available. In yet other embodiments, the network may be a combination of a WAN and a LAN. In embodiments where a user talks to a virtual agent using a phone (e.g., a landline or a cell phone), the communication may pass through a telecom network and/or a wide area network.

The user device may be a computing device used by a user for communicating with a virtual agent. A computing device could be a tablet computer, a smartphone, a laptop computer, a desktop computer, or another type of computing device. The user device may include a display that provides an interface for the user to input and/or view information. For example, a user could interact with a virtual agent using a program run on a laptop computer, such as a text-based chat program, a voice-based communication program, and/or a video-based communication program. Alternatively, in some cases, the user device could be a telephone (e.g., a landline, cell phone, etc.).

One or more resources of a virtual agent may be run on one or more servers. Each server may be a single computer, the partial computing resources of a single computer, a plurality of computers communicating with one another, or a network of remote servers (e.g., cloud). The one or more servers can house local databases and/or communicate with one or more external databases.

As also shown in FIG. 1, the user question input is made via a software platform, such as a webpage 105. Webpage 105 may then access a web service layer 110 and ultimately a chatbot intelligence center 115. The chatbot may process the user's question, retrieve the relevant data and deliver the data back to webpage 105 via web service layer 110. Then, the system may produce a chatbot response 120 to the user.

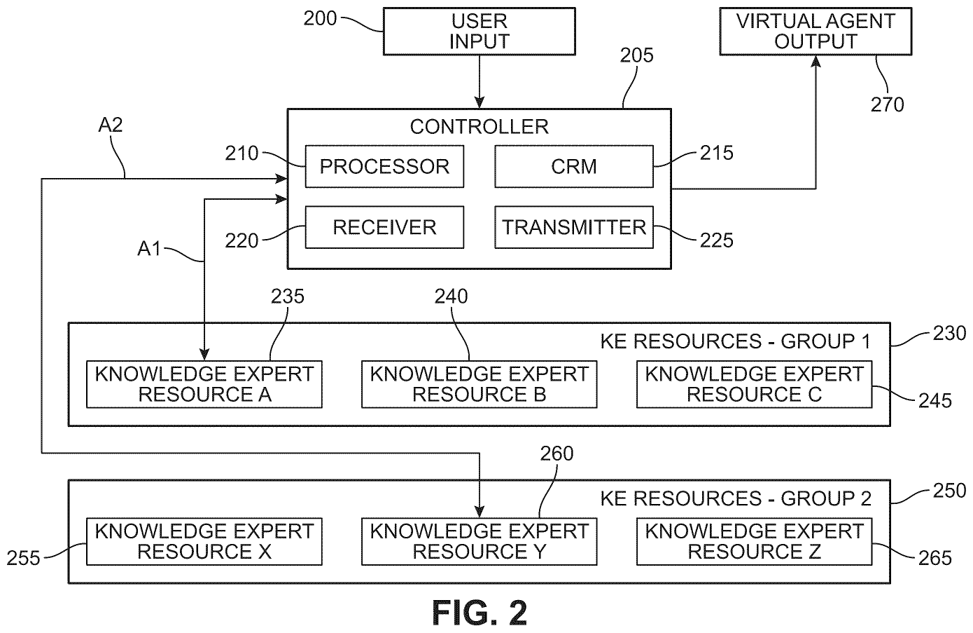

FIG. 2 is a schematic diagram of additional details of the virtual agent architecture. As shown in FIG. 2, a user may submit input 200, typically an inquiry/request for information. This user input 200 is received by the virtual agent system, particularly by a controller 205.

Controller 205 may include various computing and communications hardware. For example, as shown in FIG. 2, controller 205 may include a device processor 210 and a non-transitory computer readable medium 215 including instructions executable by device processor 210. Computer readable medium 215 may include any suitable computer readable medium, such as a memory, e.g., RAM, ROM, flash memory, or any other type of memory known in the art. Controller 205 may include other computing hardware, such as servers, integrated circuits, displays, etc.

Further, controller 205 may include networking hardware configured to interface with other nodes of a network, such as a LAN, WLAN, or other networks. For example, as shown in FIG. 2, controller 205 may include a receiver 220 and a transmitter 225. (It will be appreciated that, in some embodiments, the receiver and transmitter may be combined in a transceiver.) Receiver 220 and transmitter 225 may be configured to provide communication with other nodes of the system. Such communication may be executed via any suitable format, such as satellite communication, radiofrequency signals, etc.

Controller 205 may be provided at any suitable location. In some cases, controller 205 may be provided at a headquarters of a service provider. In other cases, controller 205 may be provided at a dedicated host facility configured to coordinate the virtual agent processes.

Computer readable medium 215 of controller 205 may include instructions for receiving a user request for one or more services. For example, as shown in FIG. 2, controller 205 may be configured to receive requests from users accessing the system via various access tools. For example, some users may access the system via the Internet, e.g., with a laptop. Some users may access the system via an application (app) on a personal electronic device, such as a smart phone. These users may submit requests for information using these access tools.

In some embodiments, the user input may be in the form of text communication. In some embodiments, the user input may be in the form of verbal communication. In some embodiments, the user may provide input via either text or verbal input. In some embodiments, the user input may be provided via a video interface.

As also shown in FIG. 2, the virtual agent may be configured to retrieve information from various stackable resources. For example, as shown by a first arrow A1 in FIG. 2, upon receiving a user input including a request for information, the system may direct a first query to a first knowledge expert resource based on the request for information. In some embodiments, the first knowledge expert resource may be selected from a plurality of knowledge expert resources. For example, the first knowledge expert resource may be selected from a first group of knowledge expert resources 230. As shown in FIG. 2, for example, knowledge expert (KE) resources group 1 (230) may include multiple resources, such as knowledge expert resource A (235), knowledge expert resource B (240), knowledge expert resource C (245), and any further number of resources suitable for the given category/type of information stored therein. As an example, FIG. 2 shows the system directing the first query to knowledge expert resource A (235) and, as indicated by double-headed arrow A1, controller 205 may receive a first set of data back from knowledge expert resource A (235).

In addition, as indicated by a second arrow A2, the system may direct a second query to a second knowledge expert resource based on the first set of data received from the first knowledge expert resource. In some embodiments, the second knowledge expert resource may be selected from a plurality of knowledge expert resources. For example, the second knowledge expert resource may be incorporated into a second group of resources, e.g., KE resources group 2 (250), which may include knowledge expert resource X (255), knowledge expert resource Y (260), knowledge expert resource Z (265), and any further number of resources. As shown in FIG. 2, the system may send the second query to knowledge expert Y based on the first set of data received from knowledge expert resource A. It will be understood that, although two knowledge expert resources are accessed in the example provided in FIG. 2, the system may access any number of knowledge expert resources. That is, the system may direct queries to as many layers/tiers of knowledge expert resources as necessary to retrieve the data required to answer the user's inquiry.

Controller 205 may be further configured to receive a second set of data from the second knowledge expert resource (in this case knowledge expert resource Y), as indicated by double-headed arrow A2. Finally, based on the second set of data, the system may deliver, to the user, a response to the first request for information (i.e., virtual agent output 270).

The first knowledge expert resource is selected based on intent recognition of the system whereby intent of the user is recognized by the system. In some embodiments, the system may be configured to learn intent of users. In addition, in some embodiments the system may be configured to learn intent of users in real time based on user feedback. For example, after providing an output to the user, the system may question the user to determine the accuracy/usefulness of the output. In some cases, the virtual agent may question the user with a simple query, such as “Was this information helpful?” If the user answers “yes,” then the system can decipher that the system's assessment of the user's intent was correct and remember to make the same assessment when receiving the same or similar user input in the future. If the user answers “no,” then the system can decipher that the system's assessment of the user's intent was incorrect and may avoid making the same assessment in the future. Over time and across many user interactions, the virtual agent may improve its intent recognition.

The system may also base its selection of the second knowledge expert resource on intent recognition. As with selection of the first knowledge expert resource, the system's intent recognition with respect to the selection of the second knowledge expert resource may be learned, in some cases based on user feedback. The system may be configured to consult with various knowledge expert resources in a predetermined order based on the intent recognition. That is, the order in which queries are directed to different knowledge expert resources is based on predetermined instructions stored in the non-transitory computer readable medium. The system may include an intent composer module that is provided with instructions as to which knowledge expert resources to consult for a given user inquiry or type of inquiry, as well as instructions as to what order the multiple knowledge expert resources are to be consulted to retrieve accurate data upon which the base the chatbot's answer to the user's inquiry.

Regardless of how many knowledge expert resources are consulted in response to a given inquiry, it is the data retrieved from the last knowledge expert resource to be consulted that will most influence the answer to be provided to the user. For this reason, the order in which the knowledge experts are consulted is determinative as to whether the answer provided to the user is accurate and/or useful. It will also be understood that, sequential consultation of knowledge expert resources provides more accurate/useful answers than accessing multiple knowledge expert resources simultaneously. Again, the selection of the second knowledge expert resource to be consulted may be based, at least in part, on the data retrieved from a first knowledge expert resource to be consulted. Likewise, the selection of the third knowledge expert resource to be consulted may be based, at least in part, on the data retrieved from the second knowledge expert resource to be consulted, and so forth.

In some embodiments, the persona of the virtual agent may be customizable between various emotional approaches. For example, some users may prefer a soft touch, i.e., a more sensitive persona to interact with. Other users may prefer a more analytical approach, laying out the facts in a blunt and matter of fact manner. Some users may prefer brief responses from the personal agent, whereas other users may prefer more detailed responses. Therefore, in some embodiments, the persona of the virtual agent may be customizable between different emotional approaches, such as “soft touch,” analytical, brief, detailed, or other designated approaches. In some embodiments, the persona may be selectable by the user. In other embodiments, the persona may be auto-selected based on interaction with the user or information about the user.

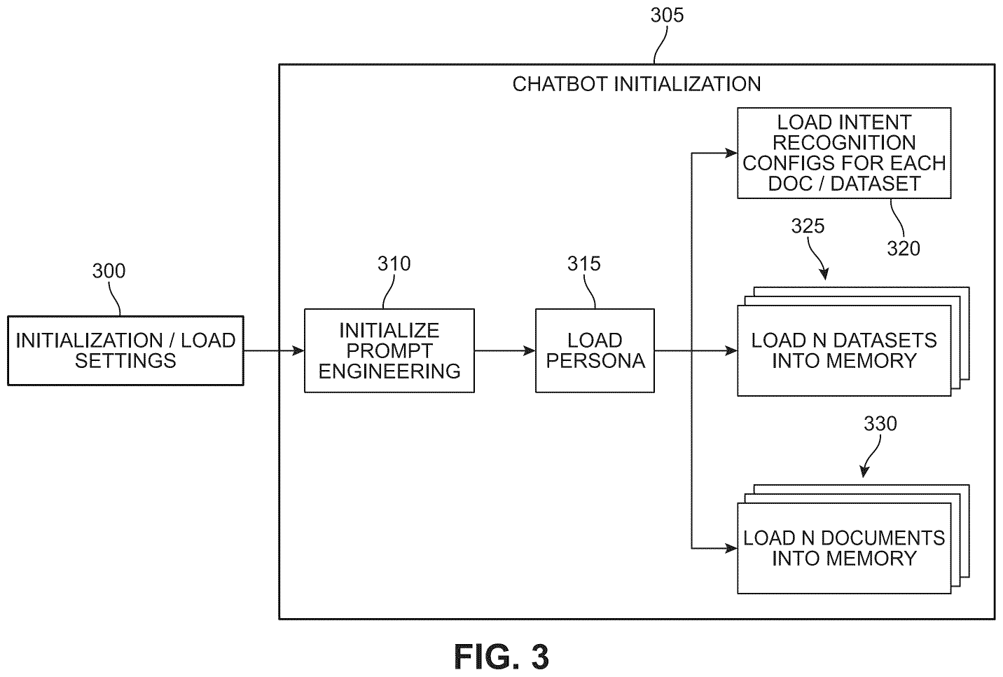

FIG. 3 is a schematic diagram of an initialization process of a virtual agent with customizable personas. As discussed above with respect to FIG. 2, the virtual agent system may include a device processor and a non-transitory computer readable medium having stored thereon instructions, executable by the processor. Via these instructions, the system may be configured to perform various tasks. As discussed above, the system may be configured to receive user input including a first request for information and, based on predetermined prompt engineering, direct a query to at least one knowledge expert resource based on the first request for information. In order to do so, the system may initialize/load various settings (300). The system may then commence chatbot initialization (305).

To initialize the chatbot, the system may initialize prompt engineering (310). The prompt engineering is the base set of instructions about how the chatbot will respond to various prompts. The system may include prompt engineering for one or more genres. For example, in some embodiments, the system may include prompt engineering for at least one of the following genres: finance, healthcare, and insurance. The non-transitory computer readable medium may include instructions for auto-selecting one of the listed genres based on the user input. In addition, the system may be configured to self-optimize the prompt engineering.

In addition to initializing the prompt engineering, the system also loads a persona (315). Various personas may include, for example, “analytical,” “soft touch,” “brief,” “detailed,” or other personas. An analytical persona may provide responses to the user that are very blunt or matter of fact. A “soft touch” persona may provide responses that are more sensitive to the emotions of the user. A brief persona may provide responses that are particularly concise, whereas a detailed persona may provide responses that provide more information/details to the user. It will be understood that the system may present one or more other types of personas with varying interactive characteristics.

In some embodiments, the type of persona may be selectable by the user. In some embodiments, the persona may be auto-selected by the system. In some cases, the persona may be auto-selected based on the user's input. For example, in order to auto-select a persona, the system may be configured to detect certain aspects about the user based on their input. Is the user extraordinarily polite or sensitive in their chat communication? If so, a “soft touch” persona may be auto-selected. At the other end of the spectrum, is the user particularly to-the-point or even crude with their communication? If so, an analytical persona may be auto-selected that provides feedback in a very matter of fact manner without much concern for the user's feelings. Is the user extremely brief with their communication? If so, a very brief and concise persona may be auto-selected. On the other hand, if the user is long-winded with their communication, a persona that provides very detailed responses may be auto-selected. It will be understood that various other types of personas may alternatively or additionally be selectable (or auto-selected).

In addition, the system is configured to load intent recognition configurations (320). That is, the intent recognition configurations are loaded from other databases into a server memory where the chatbot and personas are also hosted. The intent recognition configurations are parameters that govern how the system understands the user's questions and directs a relevant query to the correct data to retrieve useful information upon which to base a response to the user.

Further, the system is configured to load a predetermined number of datasets into memory (325). Similarly, the system may also be configured to load a predetermined number of documents into memory (330). As with the intent recognition configurations the documents and datasets are loaded from other databases into the server memory where the chatbot and personas are also hosted. Referring again to step 320, the system may load intent recognition configurations for each document and dataset that is loaded.

With the prompt engineering, persona, intent recognition configurations, datasets, and documents initialized/loaded, the system may process the user's inquiry and begin searching for information upon which to base a response.

In order to develop a virtual agent that can interact in a conversational manner with an end user, a reinforcement learning approach is utilized. Specifically, the virtual agent system uses deep reinforcement learning (DRL) to learn how to respond appropriately to user requests in a manner that is natural (i.e., human-like) and that meets the user's goals (e.g., retrieving insurance benefits information).

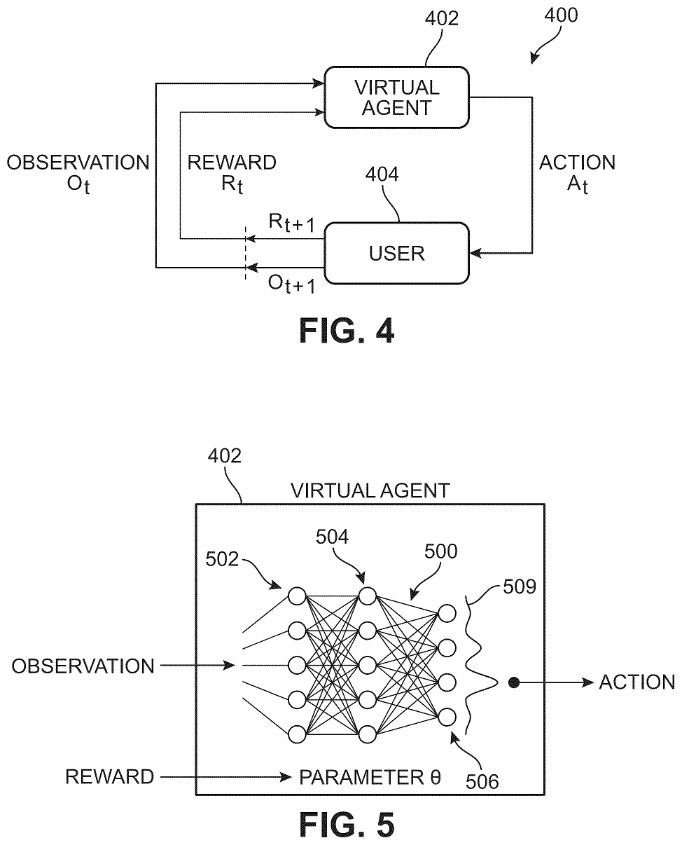

FIG. 4 is a schematic diagram of an embodiment of a reinforcement learning process. In particular, FIG. 4 is a schematic overview of a reinforcement learning system 400 for a dialogue management system. In a reinforcement learning system, a virtual agent 402 interacts with an external system or environment of some kind. In the context of dialoguing with an end user, user 404 may comprise the interacting environment.

The reinforcement learning system depicted in FIG. 4 is characterized by a repeating process: virtual agent 402 receives an observation Oₜ at time t of some aspect of the state of the system (i.e., of the user/environment). In some cases, the observation may be information related to the user's most recent response. In other cases, the observation could be part of, or the full, dialogue context. In still other cases, the observation could include other information gathered about the user, for example information from a video feed of the user that may capture nonverbal responses or gestures in addition to any verbal response. In addition to receiving an observation, virtual agent 402 may receive a reward Rₜ. In some cases, this reward could be explicitly provided by user 404 and/or the environment. In other cases, this reward could be determined by virtual agent 402 according to information from observation Oₜ, the dialogue context and/or any other information available to virtual agent 402 as it pertains to the state of the user/external system.

In response to receiving observation Oₜ, virtual agent 402 takes an action Aₜ at time t. The user responds to this action which generates a new observation Oₜ₊₁ at time t+1. An explicit or implicit reward Rₜ₊₁ may also be explicitly provided by the user or determined by virtual agent 402 using information about the user/external system. This process is repeated until learning is stopped. The virtual agent 402 learns which action A to take in response to an observation O by using the reward R as feedback to evaluate previous actions.

The learning characterized above is controlled by a particular reinforcement learning process. Some embodiments may employ a Q-Learning process, in which an agent tries to learn a function Q(s, a) that represents the “quality” of taking an action Aₜ=a in a state Sₜ=s. Thus, if an agent learns the correct Q function, they can choose an appropriate action in a state S by selecting the action A that yields the highest Q value for the current state. In the context of a dialogue management system, the state S is characterized by the virtual agent's observation O of the user's response and/or information such as the full dialogue context.

FIG. 5 is a schematic view of an embodiment of virtual agent 402 that is trained using a Deep Q Network (DQN) process. A Deep Q Network (DQN) is a Q-Learning system that uses one or more deep neural networks (DNNs) to learn the desired Q function for a given reinforcement learning task. For example, in FIG. 5, virtual agent 402 includes a deep neural network 500 (or simply, DNN 500). An input layer 502 of DNN 500 corresponds to the current observation (e.g., Oₜ of FIG. 4) of the system. Depending on the depth of the network, DNN 500 can include one or more intermediate or hidden layers (e.g., hidden layer 504). The nodes of output layer 506 each correspond to a particular Q value. Specifically, each node in the output layer 506 corresponds to a possible action (A₁, A₂, etc.) that may be taken in response to the current observation. That is, the values of the nodes in the output layer 506 correspond to the result of evaluating the Q-function (represented in FIG. 5 as function 509) in the context of a given observation O, for each possible action: Q(O, A₁), Q(O, A₂), etc. From the set of output Q values, the virtual agent selects the action corresponding to the largest Q value (i.e., the action associated with the node where function 509 is the largest). This action is then performed by the agent, and the reinforcement learning cycle shown in FIG. 4 is repeated.

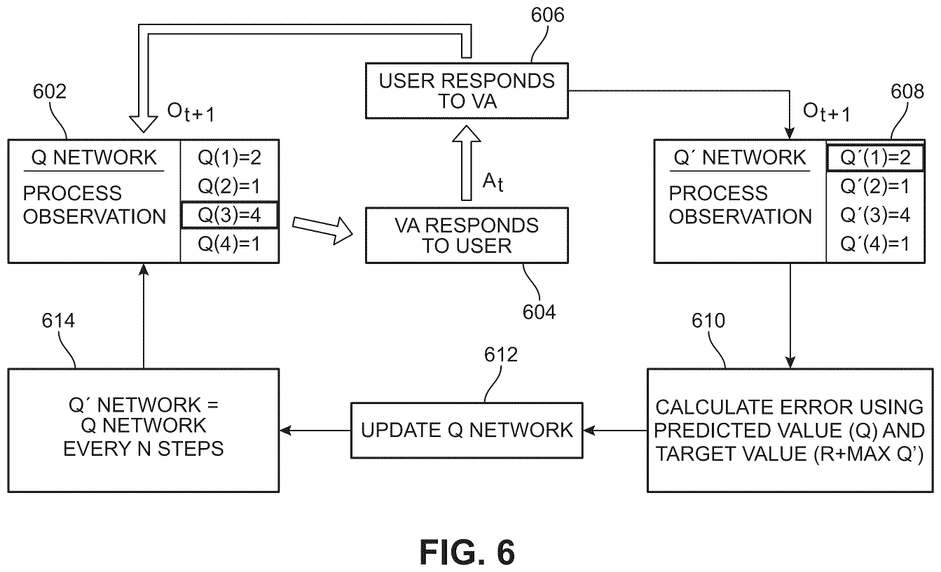

DNN 500 includes parameters (or weights) θ. During the learning process, the values of these parameters may be updated. As indicated schematically in FIG. 5, the values of these parameters depend on the rewards received during the training process. The specific relationship between the network parameters and the rewards is discussed in further detail below with respect to FIG. 6.

Although the description refers to training virtual agent 402, it may be appreciated that the learning processes described in this description may primarily occur within the dialogue management system, as it is the dialogue management system that ultimately makes decisions about what actions a virtual agent will take in response to cues from the user/environment.

FIG. 6 is a schematic view of some of the steps of the DQN training process. For clarity, some steps are not depicted here. Moreover, some of the steps have been greatly simplified.

The training process starts with the system in a known state. In the context of a dialogue management system, the state may be characterized by an observation of a user response in response to a known virtual agent action (such as a greeting). Alternatively, in some cases, the state could be characterized by a partial or full history of the dialogue. To obtain both the initial and subsequent user responses to future virtual agent actions, the dialogue management system may sample one or more training dialogues that comprise transcripts or simulations of conversations between a virtual agent and an end user.

The exemplary process of FIG. 6 may begin at a step 602, where a first DNN, referred to as the “Q Network,” may process an observation (e.g., an observation Oₜ, which is not shown). Here, “processing” the observation means feeding the observation (e.g., a user input/response) into the Q Network and making a forward pass through the network to output a set of Q values. The action associated with the largest Q value is selected, and the agent performs this action Aₜ at a step 604. In turn, the user responds to the virtual agent in a step 606, which changes the state of the user/environment and generates a new observation Oₜ₊₁. As discussed, the user response may be determined by a set of training dialogues. After the user has responded, the system may also generate a reward Rₜ₊₁ to be used later in subsequent steps.

To facilitate learning, the Q Network needs to be updated before the agent takes an action in response to the new observation Oₜ₊₁. To update the Q Network, the error between the outputs of the Q Network and their expected values must be calculated. In the DQN system, the expected values are determined by a target function. The target function (F_{TARGET}) is a function of the reward R (if any) received after taking the last action and of the Q function evaluated on the new observation. Formally, F_{TARGET}=Rₜ+ [symbol] maxₐ Q(Oₜ, a). Here, [symbol] is a learning “discount” factor, and the “max” operator is equivalent to calculating the value of Q for all possible actions and selecting the maximum value. The error is then calculated as the mean-squared-error between Q and F_{TARGET}. In practice, the DQN system uses a second “target” network, denoted Q′, to calculate F_{TARGET}. Q′ may be identical to Q, but may have different weights at some time steps in the training process. Using a separate target network, Q′ has been shown to improve learning in many contexts.

Therefore, to update the Q Network, a second (or target) DNN (denoted the “Q′ Network” in FIG. 6) is used to process the new observation and output a set of values Q′(Oₜ, A₁), Q′(Oₜ, A₂), etc., during a step 608. The maximum of these values is used, along with the reward R generated earlier, to calculate the target function. Then, the error for the Q Network is determined as a function of its outputs (Q values) and the target function in a step 610. In a step 612, the Q Network is updated via backpropagation using the error computed in step 610.

The Q′ Network is not updated during each training pass. Instead, every N steps, where N is a meta-parameter of the training process, parameters θ′ of the Q′ Network are set equal to the latest values of the parameters 0 of the Q Network. That is, every N steps, the Q′ Network is simply replaced with a copy of the Q Network during a step 614.

Some embodiments may employ other techniques that can facilitate learning with DQNs. These can include the use of epsilon-greedy strategies and experience replay as well as other known techniques.

In some embodiments, a double deep Q learning (DDQN) system may be used. The DDQN system may be similar to the DQN system with some differences. In DDQN, the first DNN (e.g., the Q Network shown in FIG. 6) may be used to determine the best action at each training step, while the second DNN (e.g., the Q′ Network) may be used to determine the associated Q value for taking that action. In some cases, using DDQN may help reduce overestimation of Q values that can occur with a DQN process.

Other embodiments could employ still further variations in the DQN architecture. For example, in another embodiment, a dueling DQN architecture could be employed.

It may be appreciated that the reinforcement learning process may be used in some contexts, but not others. For example, in one embodiment, the reinforcement learning process described above may be used while the dialogue management system is trained, but the process may not be used when the dialogue management system is tested (and/or deployed for use with real end users). Thus, in the training phase, the system may generally operate according to the process depicted in FIG. 6. However, during the testing and/or deployment phases, only the processes indicated in step 602, step 604, and step 606 may be used (as indicated by the fatter arrows in FIG. 6), while the other steps (i.e., step 608, step 610, step 612, and step 614) are not used (as indicated by the thinner arrows in FIG. 6). In terms of the Q Network, during training, both forward and backward passes are made through the network. During testing/deployment, however, only forward passes are made to generate recommended actions.

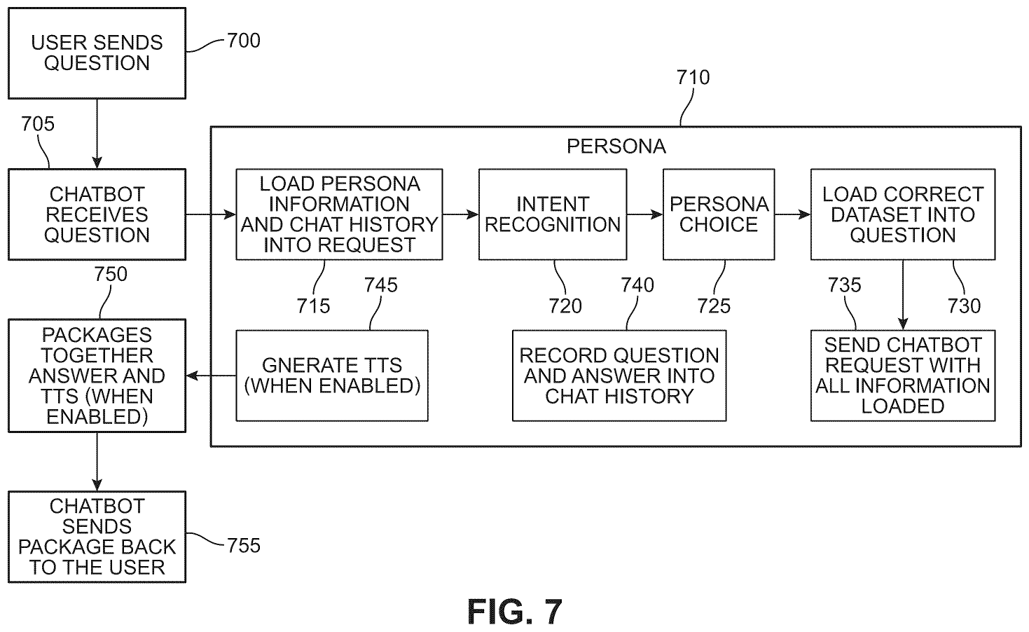

As discussed above, the persona with which the virtual agent communicates may be customizable. FIG. 7 is a schematic diagram of the role of a persona in the context of the operation of a virtual agent. As shown in FIG. 7, first, the user inputs a question to the system (700), i.e., an input into the chatbot including a first request for information. The chatbot receives the user input accordingly (705). The system then initializes a persona (710) with which to operate and loads persona information (and chat history information) into the request (715). Next, the system initializes intent recognition (720). At 725, the selection of a persona is made. Again, this selection may be by user choice or it may be automated.

In addition, based on the intent recognition, the system loads the correct dataset (730). Then, the system sends the chatbot request to a given resource (735). That is, the system directs the query to at least one knowledge expert resource based on the first request for information input by the user. Upon consulting with the knowledge expert resource(s), the system receives a set of data from the knowledge expert resource(s), generates an answer based on the relevant information found with the resource, and records the question and answer into the chat history (740).

In some embodiments, the system may have Text To Speech (TTS) capability. When TTS is enabled, the system generates a TTS output for the answer to the user's question (745). The system then packages the answer and TTS (when enabled) together (750), and the chatbot delivers a response to the user by sending the package back to the user (755) in text or audio speech (if TTS is enabled) form.

As discussed above, the persona may selectable by a user or auto-selected. In some embodiments, the persona may be auto-selected based on the user input. In other embodiments, the persona may be auto-selected based on user information. For example, the persona may be auto-selected based on user information such as age, gender, occupation, or other information/characteristics of the user.

In some embodiments, the persona may be autogenerated based on the user input. In order to autogenerate the persona, the system may utilize two artificial intelligence (AI) bots running simultaneously. One of the two AI bots generates the persona and the other of the two AI bots executes the persona.

It will be understood that the disclosed system may implement both customizable personas and stackable knowledge expert resources.

It will also be understood that stackable knowledge expert resources may be accessed proactively in order to provide information to a user even without an inquiry from the user. For example, in some embodiments, a healthcoach feature may be configured to proactively direct a query to a first knowledge expert resource. Based on data received from the first knowledge expert resource, the system may then direct a second query to a second knowledge expert resource. Based on data received from the second knowledge expert resource, the system may provide information to a user.

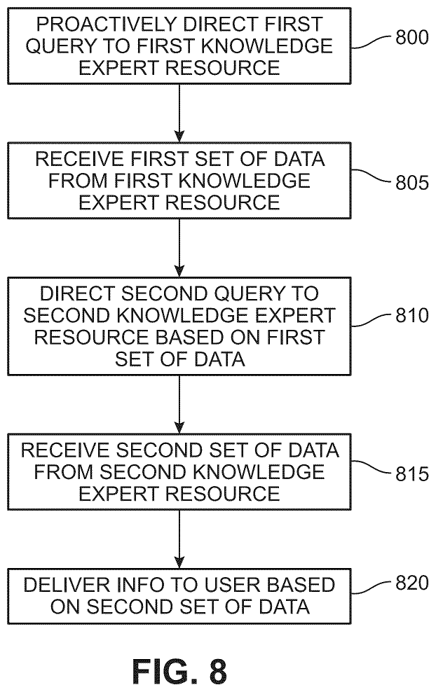

FIG. 8 is a schematic diagram illustrating a process of proactively retrieving data from multiple knowledge expert resources and providing information to a user based on the retrieved data. A virtual agent system may include a device processor and a non-transitory computer readable medium having stored thereon instructions, executable by the processor. The instructions may be for performing the steps illustrated in FIG. 8. In particular, the system may be configured to proactively direct a first query to a first knowledge expert resource based on the first request for information (800). In addition, the system may be configured to receive a first set of data from the first knowledge expert resource (805). Further, the system may be configured to direct a second query to a second knowledge expert resource based on the first set of data received from the first knowledge expert resource (810). Also, the system may be configured to receive a second set of data from the second knowledge expert resource (815). Finally, the system may deliver, to the user, information based on the second set of data (820).

The retrieval of data from the knowledge expert resources may be executed in a similar manner to that discussed above with respect to user inquiries. For example, the system may be configured to receive instructions for proactively retrieving data from one or more knowledge expert resources and providing information to the user based on the data. Also, at least one of the first knowledge expert resource and the second knowledge expert resource may be selected from a plurality of knowledge expert resources (see, e.g., FIG. 2). Further, it will be understood that the system may proactively consult with as many knowledge expert resources as necessary to retrieve the information to be provided to users. That is, any number of layers/tiers of knowledge expert resources may be accessed. In addition, the system may consult with knowledge expert resources in a serial manner, and the system may include predetermined instructions as to the order in which the knowledge expert resources will be consulted in order to retrieve information to be provided to users. Also, it will be noted that the information may be provided to the user via a text communication, audio speech communication, or video communication.

It may be appreciated that the steps of the various processes discussed above could be performed in different orders in some other embodiments.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

We claim:

1. A virtual agent system, comprising:
a device processor; and
a non-transitory computer readable medium having stored thereon instructions, executable by the processor, for performing the following steps:
receiving user input including a first request for information;
directing a query to at least one knowledge expert resource based on the first request for information;
receiving a set of data from the at least one knowledge expert resource; and
delivering, to the user, a response to the first request for information based on the set of data;
wherein delivering the response to the user is performed with a customizable persona.

2. The system of claim 1, wherein the persona may be customized to be one or more of the following:
analytical;
soft touch;
brief; and
detailed.

3. The system of claim 1, wherein the type of persona may be selectable by a user.

4. The system of claim 1, wherein the type of persona is auto-selected based on the user input or user information including at least one of user age, user gender, and user occupation.

5. The system of claim 1, wherein the persona is autogenerated based on the user input.

6. The system of claim 5, wherein the system utilizes two artificial intelligence (AI) bots running simultaneously;
wherein one of the two AI bots generates the persona and the other of the two AI bots executes the persona.

7. A virtual agent system, comprising:
a device processor; and
a non-transitory computer readable medium having stored thereon instructions, executable by the processor, for performing the following steps:
receiving user input including a first request for information;
directing a first query to a first knowledge expert resource based on the first request for information;
receiving a first set of data from the first knowledge expert resource;
directing a second query to a second knowledge expert resource based, at least in part, on the first set of data received from the first knowledge expert resource;
receiving a second set of data from the second knowledge expert resource; and
delivering, to the user, a response to the first request for information based on the second set of data.

8. The system of claim 7, wherein at least one of the first knowledge expert resource and the second knowledge expert resource is selected from a plurality of knowledge expert resources.

9. The system of claim 8, wherein the user input is in the form of text communication or verbal communication.

10. The system of claim 7, wherein the first knowledge expert resource is selected based on intent recognition of the system whereby intent of the user is recognized by the system.

11. The system of claim 10, wherein the order in which queries are directed to different knowledge expert resources is based on predetermined instructions stored in the non-transitory computer readable medium.

12. The system of claim 11, wherein the system is configured to learn intent of users in real time based on user feedback.

13. A virtual agent system, comprising:
a device processor; and
a non-transitory computer readable medium having stored thereon instructions, executable by the processor, for performing the following steps:
receiving user input including a first request for information;
based on predetermined prompt engineering, directing a query to at least one knowledge expert resource based on the first request for information;
receiving a set of data from the at least one knowledge expert resource; and
delivering, to the user, a response to the first request for information based on the set of data.

14. The system of claim 13, wherein the system includes prompt engineering for at least one of the following genres:
finance;
healthcare; and
insurance.

15. The system of claim 14, wherein the non-transitory computer readable medium further includes instructions for auto-selecting one of the listed genres based on the user input.

16. The system of claim 13, wherein the system is configured to self-optimize the prompt engineering.

17. A virtual agent system, comprising:
a device processor; and
a non-transitory computer readable medium having stored thereon instructions, executable by the processor, for performing the following steps:
proactively directing a first query to a first knowledge expert resource based on the first request for information;
receiving a first set of data from the first knowledge expert resource;
directing a second query to a second knowledge expert resource based, at least in part, on the first set of data received from the first knowledge expert resource;
receiving a second set of data from the second knowledge expert resource; and
delivering, to the user, information based on the second set of data.

18. The virtual agent system of claim 17, wherein the computer readable medium further includes instructions for receiving instructions for proactively retrieving data from one or more knowledge expert resources and providing information to the user based on the data.

19. The virtual agent system of claim 17, wherein at least one of the first knowledge expert resource and the second knowledge expert resource is selected from a plurality of knowledge expert resources.

20. The virtual agent system of claim 17, wherein the order in which queries are directed to different knowledge expert resources is based on predetermined instructions stored in the non-transitory computer readable medium.
